(19) United States
(12) Patent Application Publication
(10) Pub. No.: US 2018/0374079 A1
(43) Pub. Date: Dec. 27, 2018

(54) MULTI-SCHEME PAYMENT INTEGRATED CIRCUIT CARD, PAYMENT SYSTEM, AND PAYMENT METHOD

(71) Applicant: ScramCard Holdings (Hong Kong) Limited, Queensland (AU)

(72) Inventors: Simon HEWITT, Queensland (AU); Elisabeth SERRANO, Queensland (AU)

(21) Appl. No.: 16/062,329

(22) PCT Filed: Dec. 9, 2016
(86) PCT No.: PCT/AU2016/051216

§ 371 Date: Jun. 14, 2018

(30) Foreign Application Priority Data
Dec. 16, 2015 (AU) 2015905216

(51) Int. Cl. G06Q 20/34; G06Q 20/30; G06Q 20/32; G06Q 20/40

(52) U.S. Cl. CPC G06Q 20/3415; G06Q 20/352; G06Q 20/355; G06Q 20/3563; G06Q 20/4012; G06Q 20/305; G06Q 20/3255; G06Q 20/40145; G06Q 20/3572

(57) ABSTRACT

A system for effecting a financial transaction via multiple payment schemes from a single payment integrated circuit (IC) card is provided. The system comprises a payment IC card compatible with a payment card standard, the payment IC card having one or more selectable presets each identified by an identifying value; a wallet server storing, in association with respective identifying values, user payment scheme accounts of one or more payment schemes; and a vendor payment system configured to facilitate transactions in accordance with the payment card standard, wherein the wallet server is configured to receive an identifying value from the vendor payment system, and further wherein the wallet server is configured to effect a financial transaction with a user payment scheme account stored in association with an identifying value matching the identifying value received from the vendor payment system.

### FIELD OF INVENTION

The present invention relates to integrated circuit cards, systems, and methods for effecting financial transactions. The present invention has particular but not exclusive application with electronic payment methods.

### BACKGROUND OF THE INVENTION

It is not uncommon for a person to possess more than one credit, debit, or other electronic payment card. Owning more than one electronic payment card typically necessitates the person to carry with them each of such cards. Carrying multiple cards can be inconvenient.

One solution to carrying multiple cards is to embed in a single card multiple primary account numbers (PAN), one for each payment scheme to be provided by the one card. Such a solution, however, requires each of the payment schemes (for example, Visa™, MasterCard™, American Express™, and the like) to agree to cooperate and collaborate. For various reasons, including each scheme wanting to maintain and promote individual branding and identity, such a solution can be problematic.

### OBJECT OF THE INVENTION

It is one object of the present invention to provide a multiple payment scheme integrated circuit card that is operable to facilitate electronic payments via a number of different payment schemes using existing electronic financial systems and without requiring the collaboration of each of the different payment schemes.

This and other objects of the present invention will be made apparent from the following disclosure of the invention.

### SUMMARY OF THE INVENTION

According to a first aspect of the present invention, a system for effecting a financial. The system according to the first aspect comprises a payment IC card compatible with a payment card standard, the payment IC card having one or more selectable presets each identified by an identifier; a wallet server storing, in association with respective identifying values, user payment scheme accounts of one or more payment schemes; and a vendor payment system configured to facilitate transactions in accordance with the payment card standard, wherein the wallet server is configured to receive an identifying value from the vendor payment system, and further wherein the wallet server is configured to effect a financial transaction with a user payment scheme account stored in association with an identifying value matching the identifying value received from the vendor payment system.

In one form, the vendor payment system includes a card reader, and the payment IC card is operable to interact with the card reader to transmit thereto the identifying value for subsequent transmission to the wallet server.

Preferably, the payment IC card transmits an identifying value to the vendor payment system via an APDU message.

Preferably, the identifying value is a tag prescribed by the payment standard.

In one form, the identifying value is generated by the payment IC card from an identifier paired to a respective preset.

In one from, the payment standard is the EMV standard.

In one form, the payment standard is the PBOC standard.

In one form, the identifying value is a Primary Account Number (PAN) Sequence Number.

In one form, the vendor payment system includes a payment portal configured to receive input from a user, the payment IC card includes a display, and the payment IC card is operable to display on the display the identifying value, whereby the communication of the identifying value by the user via user input to the payment portal is facilitated.

In one form, the payment portal includes a website, and the identifying value is communicated to the payment portal by text input into the website.

In one form, the payment portal includes a at least partially automated call center, and the identifying value is communicated to the payment portal through telephony input means.

In one form, the telephony input means includes pulse dialing telephony signals generated by a telephony device.

In one form, the telephony input means includes text messages generated by a telephony device.

In one from, the payment portal includes a manned call center, and the identifying value is communicated to the payment portal by voice input.

Preferably, the identifying value is a tag prescribed by the payment card standard.

In one form, the payment standard is the EMV standard.

In one form, the payment standard is the PBOC standard.

In one form the identifying value is an expiration date value.

Preferably, the wallet server is connected to financial systems of each payment scheme.

Preferably, the wallet server is configured to provide the details of the payment scheme account stored in association with the received identifying value to a corresponding financial system to facilitate payment from a user to the vendor payment system.

Preferably, the wallet server is operable to receive from the financial system an approval or rejection of the request for payment, and inform the vendor payment system of the same.

Preferably, the payment IC card is provided with a plurality of selectable presets, one or more of the plurality of selectable presets being each paired with a respective identifier.

Preferably, the payment IC card is operable by a user to select a selectable preset, and to transmit or display the identifier paired with the selected preset.

Preferably, the payment IC card is operable by a user to select a selectable preset, generate an identifying value from the identifier paired with the selected preset, and transmit or display the identifying value.

Preferably, the wallet server is electronically accessible by a user to arrange a pairing of the details of a payment scheme account with a selectable preset of the payment IC card.

Preferably, the wallet server is configured to generate an activation code for input into the payment IC card to facilitate the pairing of a selectable preset with the account details of a payment scheme.

Preferably, the payment IC card is operable to receive from the user an indication of a selected preset of the payment IC card to activate, further receive from the user a code for activating the selected preset, and further operable to compare the received code with an activation code pre-stored in the payment IC card for the selected preset.

Preferably, the selected preset is paired with the account details of the payment scheme if the code received from the user matches the activation code pre-stored in the payment IC card for the selected preset.

Preferably, an identifier is generated using the activation code, and the generated identifier is paired to the selected preset.

Preferably, the wallet server, upon receipt of the identifying value, is operable to identify and retrieve the details of the payment scheme account stored in association with a matching identifying value, and provide the details to the financial system of the corresponding payment scheme.

According to a second aspect of the present invention, there is provided a payment integrated circuit (IC) card for effecting a financial transaction in accordance with a payment standard. The payment IC card comprises a human interface including a display and a keypad; an integrated circuit (IC) chip compatible with the payment standard; and a plurality of selectable presets each respectively associated with an identifier, each identifier is, or is used to generate, an identifying value associated with a payment scheme account, wherein the selectable presets are operable by a user to configure the payment IC card for transaction via one of the plurality of payment scheme accounts.

In one form, the payment IC card is configurable via the selectable presets to set one of the identifying values as an identifying value to be transmitted to a vendor payment system when requested thereby.

Preferably, the payment IC card is configured to transmit the set identifying value to the vendor payment system in an APDU response to an APDU command from the vendor payment system.

Preferably, the identifying value is a tag prescribed by the payment standard.

In one form, the identifying value is a Primary Account Number (PAN) Sequence Number.

In one form, the payment IC card is configurable via the selectable presets to set one of the identifying value as an identifying value to be displayed on the display of the human interface.

Preferably, the set identifying value is displayed on the display of the human interface in a format facilitating human reading thereof.

In another form, the set identifying value is displayed on the display of the human interface in a format facilitating machine reading thereof.

Preferably, the identifying value is a tag prescribed by the payment standard.

In one form, the identifying value is an expiration date value.

Preferably, the payment IC card is configured to operate in a first mode where an authentication code representing the identity of the user is inputted to the payment IC card, and the payment IC card is operable to generate a security PIN using one or more of the authentication code, a current time, the selected preset, and a pre-stored random seed, and wherein the security PIN is adapted for input to the vendor payment system to authorize the transaction.

In one form, the authentication code is a number.

In one form, the authentication code is a code generated from biometric information of the user.

Preferably, the payment IC card further comprises an imaging device for imaging a fingerprint of the user.

Preferably, the payment IC card further comprises an imaging device for imaging a retina of the user.

Preferably, the payment IC card is further configured to operate in a second mode in which an authentication code representing the identity of the user is inputted to the payment IC card, and upon successful validation of the authentication code, the payment IC card unlocks an NFC communication capability of the payment IC card allowing the set identifier to be transmitted via NFC communication to the vendor payment system.

Preferably, the payment IC card is preprogrammed with a plurality of activation codes, one for activating each of the selectable presets.

Preferably, the payment IC card is operable to receive a code from the user and compare the received code with each of the preprogrammed activation code, the payment IC card configured to activate a selectable preset when the received code matches the preprogrammed activation code for the selectable preset.

In one form, the selectable presets are mapped to the keypad, whereby operation of the keypad operates the selectable presets.

According to a third aspect of the present invention, a method for conducting an electronic funds transaction over any one of a plurality of payment schemes from one payment IC card is provided. The method comprises pairing details of a payment scheme account with an identifying value on a server, the server generating an activation code, and entering the activation code into the payment IC card to activate a selectable preset on the payment IC card, wherein the selectable preset activated by the activation code is a preset which has further associated therewith an identifier that is, or is used to generate, an identifying value matching the identifying value paired with the details of a payment scheme account on the server.

Preferably, the method further comprises operating the payment IC to have the identifying value associated with the selectable preset transmitted to the server, and the server sending details of the payment scheme account stored in association therein with a matching identifying value transmitted to a financial system of the payment scheme.

According to a fourth aspect of the present invention, a method for conducting an electronic payment transaction over any one of a plurality of payment schemes from one payment IC card is provided. The method comprises selecting a preset on a payment IC card, the selected preset having an identifier associated therewith, the identifier being, or being used to generate, an identifying value; providing the identifying value to a vendor payment system, transmitting the identifying value from the vendor payment system to a server, identifying at the server a payment scheme account corresponding to the transmitted identifying value, and transmitting the details of the identified payment scheme account to a financial system of a payment scheme corresponding to the payment scheme account to effect a financial transaction using the payment scheme.

Preferably, the method, in one form, receives an input indicative of whether the transaction to be conducted is a remote transaction or a point-of-sale transaction. In one form, the method, when applied to a remote transaction, further comprises the payment IC card receiving a PIN after the preset is selected, and displaying an identifying value associated with the selected preset if the PIN is valid, wherein the identifying value is displayed in a suitable form for input to the vendor payment system.

In one form, the method when applied to a remote transaction, further comprises the payment IC card receiving a PIN, the payment IC card generating the identifying value at least partially based on the PIN, and displaying the generated identifying value, wherein the identifying value is displayed in a suitable form for input to the vendor payment system.

In one form, the identifying value is generated further at least partially based on an identifier paired to the selected preset.

In one from, the identifying value is an identifier paired to the selected preset.

Preferably, the identifying value is a tag prescribed by a payment standard that the payment IC card is compatible with.

In one form, the identifying value is a date.

In one form, the identifying value is an expiration date of a payment scheme account.

In one form, the method, when applied to a point-of-sale transaction, further comprises the payment IC card receiving a PIN after the preset is selected, and making the identifying value associated with the selected preset available for provision to the vendor payment system if the received PIN is valid

In one form, the method, when applied to a point-of-sale transaction, comprises the payment IC card receiving a PIN, the payment IC card generating an identifying value at least partially based on the received PIN, and making the generated identifying value available for provision to the vendor payment system.

In one form, the identifying value is generated further at least partially based on an identifier paired to the selected preset.

In one from, the identifying value is an identifier paired to the selected preset.

Preferably, the method further comprises generating a security number based at least in part on the received PIN, and displaying the security number, wherein the security number is a one-time passcode (OTP) for input into the vendor payment system to authenticate a user of the payment IC card.

Preferably, the method, when applied to a point-of-sale transaction, further receives an input indicative of whether the transaction is an NFC transaction, and if the receive input indicates that the transaction is an NFC transaction, receiving an authorizing PIN, unlocking an NFC communication means integrated in the payment IC card if the authorizing PIN is valid, and transmitting the identifying value associated with the selected preset via NFC to the vendor payment system.

Preferably, the identifying value is a tag prescribed by a payment standard that the payment IC card is compatible with.

In one form, the identifying value is a PAN sequence number.

The above aspects, variations, and options are to be understood as comprisable within the invention singly, or in combination with each other.

### BRIEF DESCRIPTION OF THE DRAWINGS

In order that the present invention can be more readily understood, reference will now be made to the accompanying drawings which illustrate preferred embodiments of the invention and wherein:

FIG. 1 illustrates a multi-scheme payment system according to the present invention;

FIG. 2 illustrates a multi-scheme payment integrated circuit card according to the present invention;

FIG. 3 illustrates displays of the multi-scheme payment integrated circuit card in an ACTIVATE mode;

FIG. 4 is a flow chart describing an ACTIVATE operation;

FIG. 5 illustrates displays of the multi-scheme payment integrated circuit card in a DEACTIVATE mode;

FIG. 6 is a flow chart describing a DEACTIVATE operation;

FIG. 7 illustrates displays of the multi-scheme payment integrated circuit card in a remote transaction mode;

FIG. 8 is a flow chart describing a remote transaction operation using a multi-scheme payment integrated circuit card according to the present invention;

FIG. 9 illustrates displays of the multi-scheme payment integrated circuit card in a POS/ATM transaction mode;

FIG. 10 is a flow chart describing a POS/ATM transaction operation using a multi-scheme payment integrated circuit card according to the present invention;

FIG. 11 illustrates displays of the multi-scheme payment integrated circuit card in an NFC tap transaction mode; and

FIG. 12 is a flow chart describing an NFC tap transaction operation using a multi-scheme payment integrated circuit card according to the present invention.

### DETAILED DESCRIPTION OF PREFERRED EMBODIMENTS

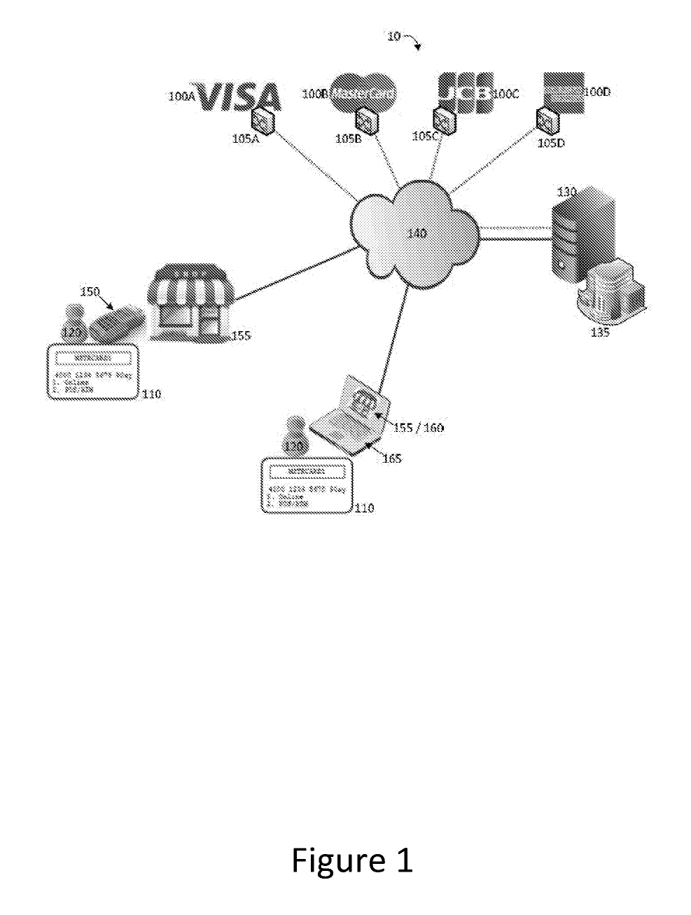

With reference to FIG. 1, a multi-scheme payment system 10 according to a first aspect of the present invention is described.

The multi-scheme payment system 10 is a system for facilitating electronic payments, such as credit and debit card payments. The system 10 allows users 120 to make electronic payments using any one of a number of payment schemes 100A, 100B, 100C, 100D with which the users 120 have accounts. The electronic payments are effected from a single payment integrated circuit card 110 (hereinafter referred to as a payment IC card 110), regardless of the payment scheme 100A-D used.

The system 10 includes a wallet server 130 connected to a network 140. The wallet server 130 is managed by a wallet provider 135 and stores therein a wallet account for each user 120. Each user's wallet account stores details for each payment scheme 100A-D that the user 120 has an account with. In one form, each user wallet account stores one or more of the name, primary account number, card type, expiration date, and card code verification number (e.g. CCV2), for one or more credit or debit cards (e.g. cards corresponding to each of payment schemes 100A-D) that the user 120 owns. The account details for each payment scheme 100A-D (hereinafter referred to as payment scheme accounts) are stored in the wallet server 130 in association with an identifying value, or information for generating an identifying value, that distinguishes one payment scheme account from another.

A vendor payment system, for example a point-of-sale (POS) or ATM device 150 (hereinafter referred to as a POS device for convenience), and/or an online payment portal 160 accessible via an electronic device 165, are connected to the wallet server 130 via the network 140. The POS device 150 is preferably an NFC (Near Field Communication) enabled device, and accordingly operable to read the payment IC card 110 via both NFC communication and physical hardware interfacing. Also connected to the wallet server 130 via the network 140 are financial systems 105A, 105B, 105C, 105D for the one or more payment schemes 100A-D supported by the wallet server 130.

The payment schemes 100A-D, as illustrated in FIG. 1, include credit institutions such as Visa™, MasterCard™, JCB™, and American Express™, and can further include other transactional institutions whether monetary/financial in nature or otherwise, such as PayPal™, Bitcoin exchanges, rewards/frequent-flyer point exchanges, store card issuers, bank/debit/cash card issuers, gift card issuers, and the like.

The payment IC card 110 is an integrated circuit (IC) card issued by the wallet provider 135. The payment IC card 110 conforms to a payment IC card standard. In one form, the payment IC card 110 conforms to the EMV (Europay™, MasterCard™′ and Visa™) standard. Accordingly, the payment IC card 110 is accepted at any terminal, machine, and/or vendor that is registered appropriately for EMV transactions. It is to be understood, however, that the payment IC card is not so limited and may additionally or alternatively conform to the PBOC (People's Bank of China) standard or other standard.

As will be described in greater detail below, the payment IC card 110 is issued with a primary account number from a payment scheme. The payment scheme issuing from the primary account number can be one of the payment schemes 100A-D of the system 10, or can be a different payment scheme. It is however generally preferable if the payment scheme issuing the primary account number is one that is widely accepted by vendors 155 across the world. The payment IC card 110 is configured to have a plurality of selectable presets, each paired with at least one identifier. An identifying value which is either the identifier itself, or generated therefrom, is communicated to the wallet server 130 as part of a transaction, and identifies to the wallet server 130 a payment scheme account desired to be used by the user 120 to perform the transaction. The identifying values are communicated to the wallet server 130 by way of, for example, the POS device 150 (either by NFC communication or physical hardware interfacing), or by the user 120 providing the identifying values through the payment portal 160, or by any other form of communication including telephone, verbally written form, and the like.

In the preferred embodiment, the identifying values are tags that are prescribed by the payment standard. In the case of the payment standard being the EMV standard, the identifying values can be, for example, a Primary Account Number Sequence Number (tag #5F34), card expiration number (tag #57), and the like. The identifying values can therefore be communicated via messaging protocols prescribed by the payment standard, for example ISO-8583.

As will be described in greater detail below, a financial transaction between the user 120 and the vendor 155 is realized by the user 120 operating the payment IC card 110 to indicate which payment scheme the user 120 desires to conduct the transaction with. An identifier corresponding to a preset of the payment IC card 110 that has been activated for the desired payment scheme is used as an identifying value, or used to generated an identifying value, which is sent to the wallet server 130, for example via the POS device 150 or the payment portal 160. The wallet server 130, upon receiving the identifying values, determines which of the payment scheme accounts the user 120 desires to conduct the transaction with. The desired payment scheme account is identified by matching the identifying value sent to the wallet server 130 with the identifying values stored in the wallet server 130, or generated from information stored in the wallet server 130, in association with each payment scheme account. Once the desired payment scheme is identified, the wallet server 130 retrieves the actual user details for the desired payment scheme from the user's wallet account. In an exemplary case where the user 120 desires to transact via the VISA™ payment scheme, for example, the user's VISA™ primary account number, VISA™ card expiry date, and the like are retrieved from the user's wallet account. These details are then transmitted by the wallet server 130 to the financial systems 105A of the VISA™ payment scheme 100A.

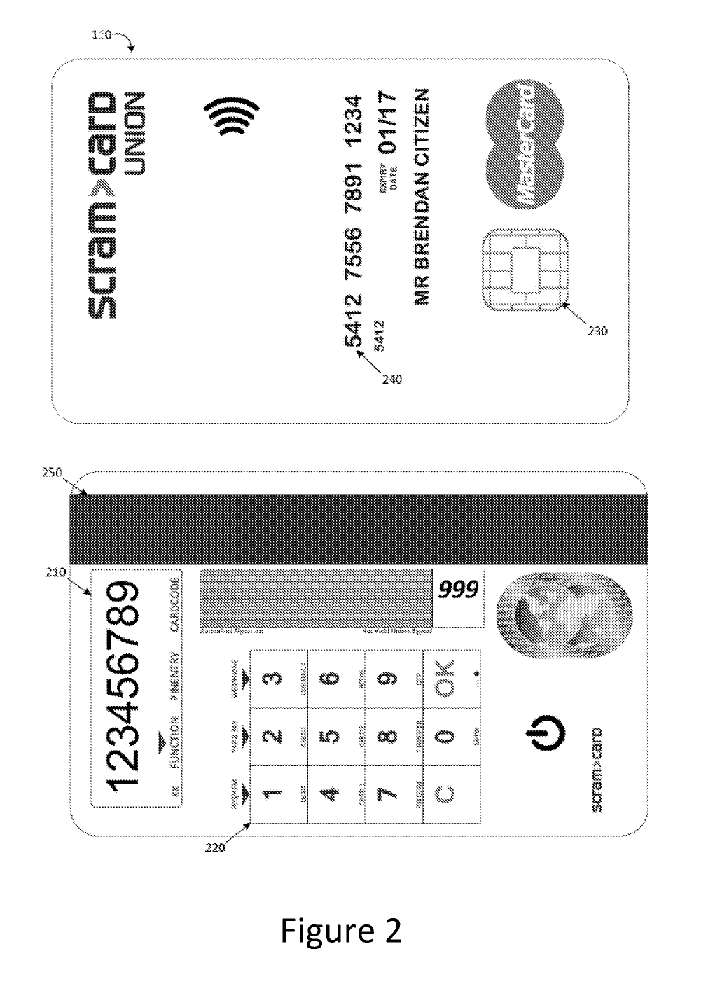

With reference to FIG. 2, the payment IC card 110 is described in greater detail. The payment IC card 110 is an integrated circuit card including a display 210, and keypad 220. The payment IC card 110 integrates therein a processor and memory to perform a range of functions. An interface chip 230 is provided to interface the processor and memory with external devices, such as the POS device 150. Software and/or firmware is stored in the memory of the payment IC card 110 to provide various user functions. These user functions will be described in greater detail below. Other hardware may be integrated in the payment IC card 110, including for example NFC communication hardware, Bluetooth™ communication hardware, backlighting, and the like.

The display 210 is operable to display thereon user prompts, user inputs, card generated outputs, and other information for the user 120. The display 210 in one form is a liquid crystal display. In other forms, the display 210 may be an LED display, OLED display, ELD, electronic paper display, and the like.

The keypad 220 allows interaction with the software and/or firmware programs stored in the memory of the payment IC card 110. As will be detailed below, the keypad 220 acts as an interface for the user 120 to, for example, activate a new payment scheme in the payment IC card 110, deactivate an existing payment scheme therefrom, enter in a PIN, and the like. The keypad 220, in a preferred embodiment, further realizes the plurality of selectable presets.

As illustrated, one surface of the payment IC card 110 is detailed with a card number 240, which is the Primary Account Number (PAN) of the card.

While various elements of the payment IC card 110 have been illustrated in a certain arrangement in FIG. 2, it is to be understood that the illustration of FIG. 2 is not limiting. A skilled addressee will understand that the various elements, for example the keypad 220, may be arranged in other positions on the payment IC card 110, such as on a back surface thereof. The keypad 220 may also be a physical device, such as an electro-mechanical keypad, or a logical device such as a touchscreen device separate to or integrated with the display 210.

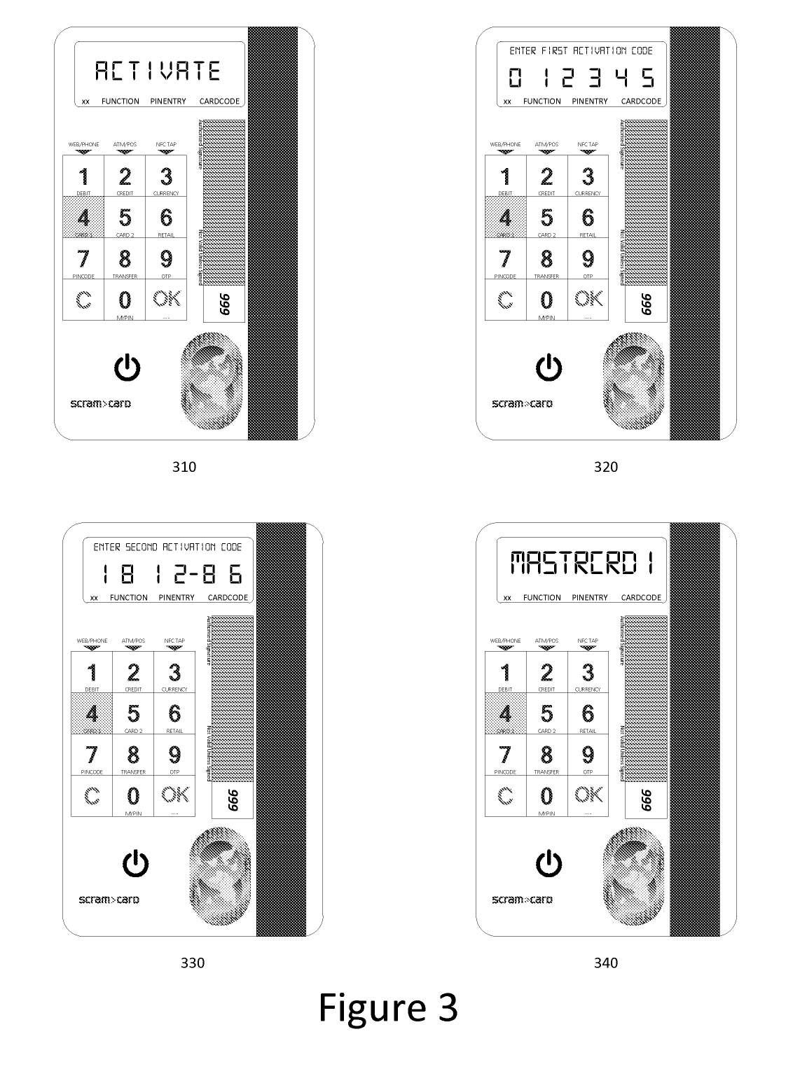

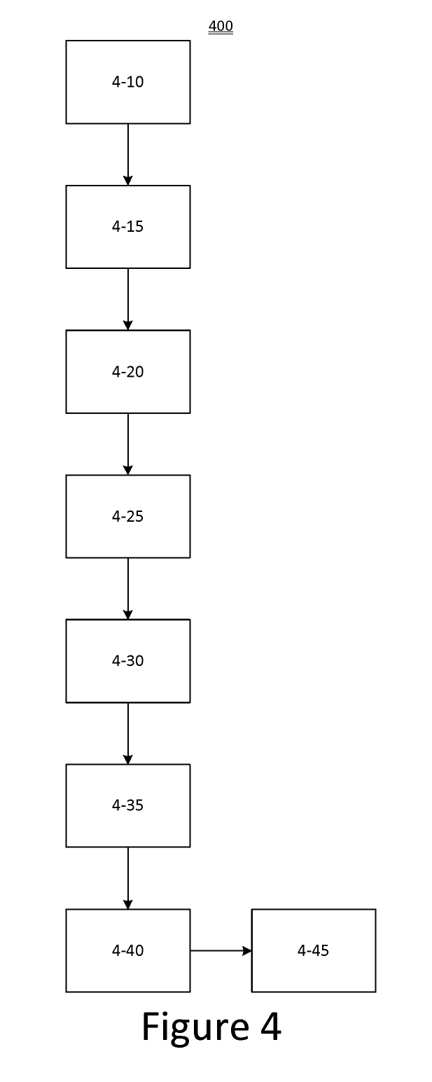

With reference to FIGS. 3 and 4, an activation operation 400 of the payment IC card 110 to activate a selectable preset of the payment IC card 110 for a payment scheme account is described. The activation operation 400 is preferably performed in tandem with an online or telephone based operation in which the user 120 indicates to the wallet server 130 which of the user's payment scheme accounts should be associated with which selectable preset of the payment IC card 110. In one embodiment, the selectable presets of the payment IC card are each mapped to a key, or combination of keys, on the keypad 220.

For ease of description, the following operation 400 is described in relation to an example where the user 120 has indicated to the web server 130 that they desire to activate selectable preset ‘4’ of their payment IC card 110 for use with their MasterCard™ account. It should be understood that the following operation 400 is applicable regardless of which selectable preset of the payment IC card 110 is desired to be activated, and regardless of which payment scheme the selectable preset is to be activated for. Additionally, for ease of description, selectable preset ‘4’ is assumed to be selected by operating physical key ‘4’ on the keypad 220, and the terms “key ‘4’” and “selectable preset ‘4’” are hereinafter used interchangeably.

The operation 400 to activate key ‘4’ of the payment IC card 110 for use with the user's MasterCard™ payment scheme account commences at 4-10 as illustrated in FIG. 4, after or in tandem with the user 120 performing the aforementioned tandem operation to indicate the same to the wallet server 130. At 4-10, the user 120 presses key ‘4’ on the keypad 220 to commence the operation 400.

At 4-15, the display 210 of the payment IC card 110 displays a suitable message to inform the user 120 that they have commenced an activation operation. The display 210 may, for example, display the word “ACTIVATE” as illustrated by screen 310 of FIG. 3 to indicate to the user that key ‘4’ is available as a suitable candidate for activation. If, on the other hand, key ‘4’ has already been activated for use with a payment scheme, the display 210 will display the name or other description of the payment scheme that has already been activated on key ‘4’.

At 4-20, a screen 320 (FIG. 3) prompts the user 120 to enter in a first activation code. The first activation code is provided to the user 120 by the wallet server 130 during the aforementioned tandem operation, and is specific to key ‘4’. The first activation code is entered into the payment IC card 110 by the user 120 by way of the keypad 220. The screen 320 (FIG. 3) is operable to display the digits as they are entered by the user 120 via the keypad 220. The activation code validates the user's authority to activate key ‘4’ of the payment IC card 110. The requirement for a first activation code prevents erroneous and/or unauthorized activation of the selectable presets.

At 4-25, the processor of the payment IC card 110 checks if the first activation code entered by the user is valid. The first activation code entered by the user is valid if it matches an activation code pre-stored in the payment IC card 110 with respect to key ‘4’, or generated by the payment IC card using an algorithm specific to key ‘4’. If the first activation code is determined to be invalid, the activation operation 400 is concluded. If the first activation code is determined to be valid, the operation proceeds to 4-30.

At 4-30, the display 210 of the payment IC card 110 optionally displays a screen 330 (FIG. 3) to prompt the user 120 to enter an optional second activation code. The second activation code is also provided to the user by the wallet server 130 during the aforementioned tandem operation. The second activation code acts as a further check against erroneous and/or unauthorized key programming. The second activation code is entered by the user 120 by way of the keypad 220.

At 4-35, the processor of the payment IC card 110 checks if the second activation code entered by the user 120 is valid for key ‘4’, and if so, activates key ‘4’ for use with the user's MasterCard™ account. The second activation code entered by the user is valid if it matches an activation code pre-stored in the payment IC card 110 with respect to key ‘4’, or generated by the payment IC card using an algorithm specific to key ‘4’, or otherwise matches a suitable pre-stored or generated code. If the second activation code is invalid, the activation operation 400 is concluded. If the second activation code is determined to be valid, the operation proceeds to 4-40.

In one form, one or both of the first and the second activation codes are comprised of two parts. A first part of the code includes an activation sequence that is to be compared with and matched with a corresponding activation sequence pre-stored on or generated by the payment IC card 110 with respect to key ‘4’. A second part of the code is an identification sequence which identifies to the payment IC card 110 the payment scheme (e.g. MasterCard™, Visa™ AMEX™) that key ‘4’ is being activated for.

In the example illustrated in screen 330 of FIG. 3, the second activation code is a 6 digit number where the first four digits are an activation sequence generated by the wallet server 130, and the last two digits are an identification sequence to indicate to the payment IC card 110 the type of payment scheme being linked to the key.

A payment scheme description to be displayed on the display 210 of the payment IC card each time key ‘4’ is selected can be determined from the second part of the second activation code via a pre-arranged mapping of identification sequences to payment scheme descriptions. An exemplary mapping is shown below:

| | Last 2 Digits | | | | | | | | |
|---|---|---|---|---|---|---|---|---|---|
| | 06 | 16 | 23 | 45 | 57 | 64 | 79 | 86 | 91 |
| Payment | Maestro | JCB | Electron | VISA | VISA | Diners | AMEX | MasterCard | UnionPay |
| Scheme | | | | DR | CR | | | | |
| Description | | | | | | | | | |

At 4-40, the payment IC card 110 associates a payment scheme description with key ‘4’, which will be displayed on the display 210 each time key ‘4’ is now operated. In the example illustrated by FIG. 3, the second activation code is the code that contains an identification sequence, and the payment scheme description to be displayed is determined therefrom. The identification sequence of the exemplary second activation code illustrated by FIG. 3 is ‘86’, accordingly, the payment IC card 110 identifies key ‘4’ as being activated for a MasterCard™ account, and an appropriate display name of, for example “MASTRCRD1” is associated with key ‘4’ for display on the display 210 each time key ‘4’ is pressed. An exemplary screen 340 of the payment IC card 110 depicting the display name is illustrated in FIG. 3. It is to be understand that the second part of the second activation code is not limited to being the last 2 digits. The second part of the second activation code can be any predetermined derivation of the second activation code.

Next at 4-45, one or more identifiers are paired to key ‘4’. In one form, the one or more identifiers are already pre-stored on the payment IC card 110 in association with key ‘4’, and therefore no further operation is required to pair them to key ‘4’. In this form, matching identifiers are also already pre-stored at the wallet server 130 in association with selectable preset ‘4’, and no further operation is required at the wallet server 130 either. The pre-stored identifiers are locally unique, that is no other selectable preset of the payment IC card 110 is/will be paired with the same identifier(s). In another form, the one or more identifiers are generated by the payment IC card 110 from the first and/or second activation codes inputted thereto at steps 4-20 and 4-30. Matching identifiers are similarly generated by the wallet server 130 using the same first and/or second activation codes, and stored in association with selectable preset ‘4’ on the wallet server 130. The first and/or second activation codes, and/or the algorithm used to generate the one or more identifiers therefrom, are configured to ensure that the generated identifiers are locally unique (i.e. unique within the payment IC card 110) and thereby no other selectable preset of the payment IC card 110 will have identical identifiers generated therefor.

Once activated, future operation of selectable preset ‘4’ will cause the payment IC card 110 to present or otherwise make available, in one form of the present invention, the one or more identifiers paired therewith as identifying values, and in another form of the present invention, identifying values generated using the one or more identifiers paired therewith. It should be noted that in the form where identifying values are generated using the one or more identifiers, the need for the one or more identifiers to be locally unique can be relaxed or altogether obviated if the algorithm for generating the identifying values from the one or more identifiers results in identifying values that are locally unique, at least for a given duration in time.

In one form, at least two identifiers are paired to each activated preset. A first identifier is adapted for used with POS/ATM transactions, where the payment IC card 110 is presented or otherwise physically interacted with the POS device 150, and the second identifier is adapted for use with remote transactions, where the payment IC card 110 is not presented or not otherwise physically interacted with the POS device 150.

The difference between the first and the second identifiers is that the first identifier is (or is used in the generation of) a first identifying value that has a format that may be better suited for electronic transmission between the payment IC card 110 and the POS device 150, for example, through Application Protocol Data Unit (APDU) messages, and further is a piece of information that would be likely exchanged in the process of conducting a POS/ATM transaction according to the payment standard.

Conversely, the second identifier is (or is used in the generation of) a second identifying value that has a format that may be better suited for human interaction with, such that manual human input into, for example, an ecommerce website of the payment portal 160 is not made too arduous. Further, the second identifying value is a piece of information that would be likely exchanged in the process of conducting a remote transaction. Preferably, the second identifying value contains 12 or less alphanumerical characters, and more preferably 9 or less alphanumerical characters, and even more preferably 6 or less alphanumerical characters, and still more preferably, 4 or less alphanumerical characters.

The first identifying value is, in a preferred embodiment, a tag prescribed by the payment standard, for example a PAN Sequence Number prescribed by the EMV payment standard.

The second identifying value is, in a preferred embodiment, a tag prescribed by the payment standard, for example, a card expiration date prescribed by the EMV payment standard.

As will be described in greater detail below, the identifying values are ultimately sent to the wallet server 130 and matched therein to determine which payment scheme account in a user's wallet account to transact with.

In a further embodiment, a third identifier can be paired to each activated preset. The third identifier is a seed suitable for generating a one-time PIN from. Alternatively, rather than a separate third identifier, either of the first or second identifiers can be configured to serve as the seed. As a further alternative, a locally global (i.e. global within the payment IC card 110) seed can be used by all presets, and an appropriate operation/algorithm employed to ensure a one-time PIN that is locally unique to a preset (at least for a given duration in time) is generated. The above alternatives reduce the storage/memory requirements of the payment IC card 110. As will be described in greater detail below, the one-time PIN can be used to authenticate the user 120 in POS/ATM transactions.

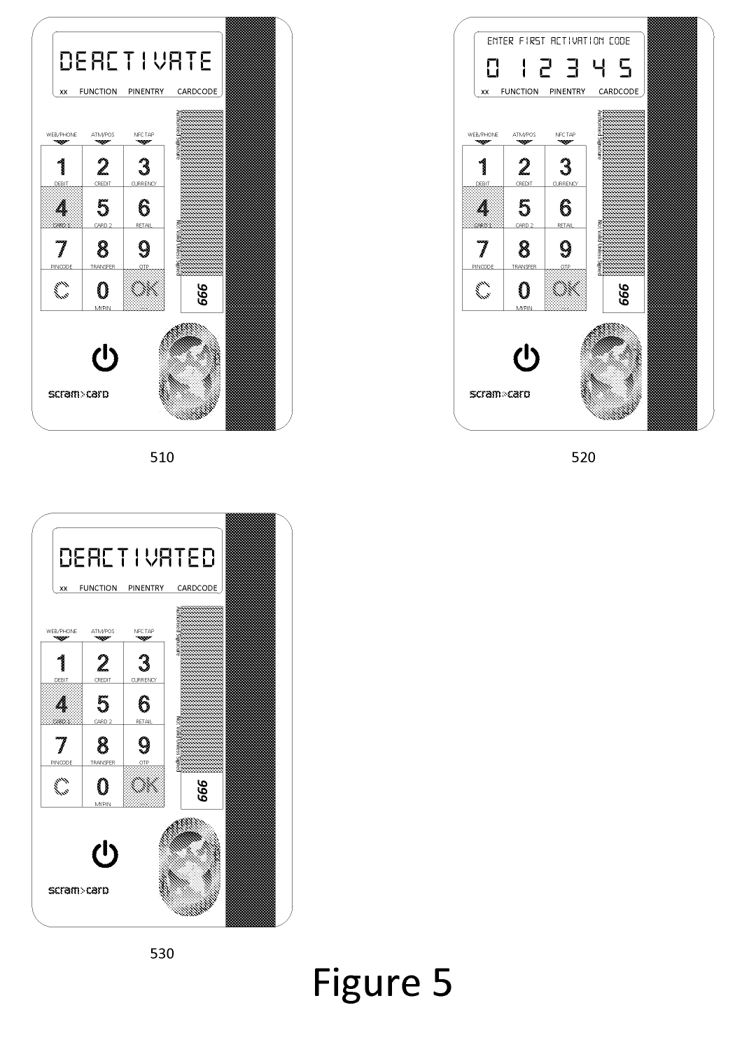

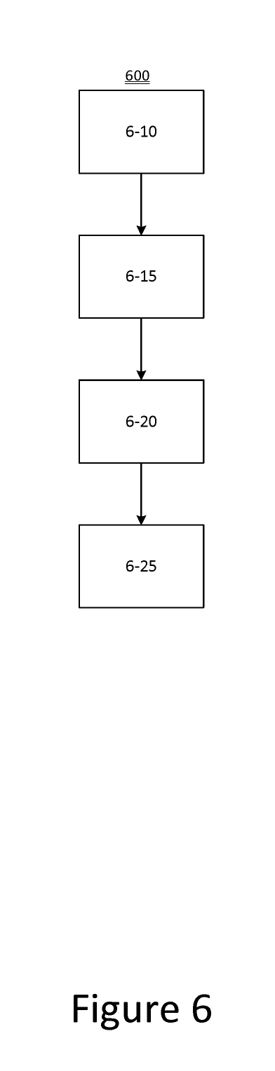

With reference now to FIGS. 5 and 6, an operation 600 for deactivating a selectable preset on the payment IC card 110 is described.

The operation 600 to deactivate a payment scheme account from the payment IC card 110 commences at 6-10 in the flowchart of FIG. 6 when the user 120 presses a preset sequence of keys on the keypad 220. In one form, the sequence of keys is a first press of the key to be deactivated followed by 5 consecutive presses of the “OK” key in quick succession.

At 6-15, the display 210 of the payment IC card 110 displays a suitable message to inform the user 120 that a deactivation operation is permitted for the key and that the payment IC card 110 is ready to commence the deactivation process. In one form, the display 210 displays the word “DEACTIVATE” as illustrated in FIG. 5 with reference to screen 510.

At 6-20, the user 120 enters into the payment IC card 110 a deactivation code provided to them by the wallet server 130. The deactivation code is provided to the user 120 when the user 120 informs the wallet server 130 of their desire to deactivate a key. In one form, the user 120 informs the wallet server 130 of their desire to deactivate a key via online means, such as through a web portal, or via telephone. The deactivation code is entered into the payment IC card 110 by the user 120 by way of the keypad 220. A screen 520 (FIG. 5) prompts the user 120 to enter the deactivation code, and displays the digits as they are entered by the user 120. The deactivation code is specific to the key being deactivated.

At 6-25, the processor of the payment IC card 110 confirms if the deactivation code entered by the user 120 is valid for the key to be deactivated. If the code is valid, the key is deactivated, and future presses of the key will not result in the necessary processes for effecting a transaction. In particular, deactivation of the key results in the identifier(s) paired to the key to no longer be available for use, for example for presentation on the display 210, or to be available to the POS device 150, or for the generation of identifying values. The deactivated key is also made available for future activation for new payment scheme accounts. The display 210 displays a screen 530 (FIG. 5) to confirm to the user 120 that the key has been delinked/deactivated.

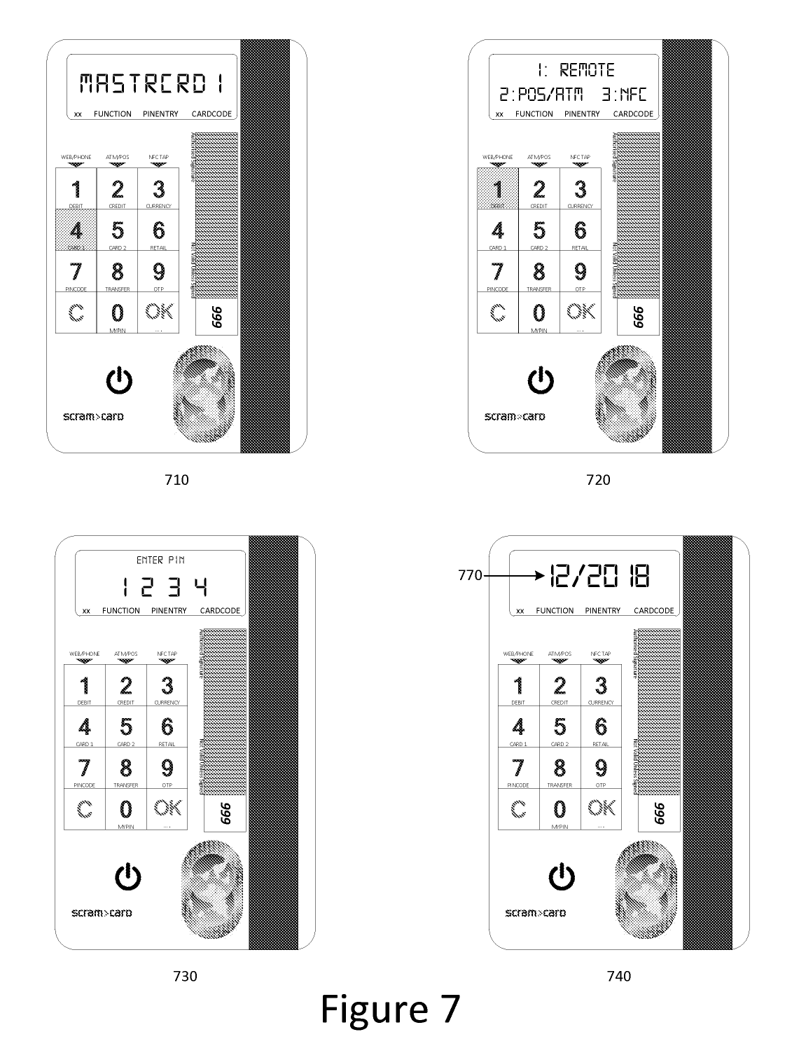

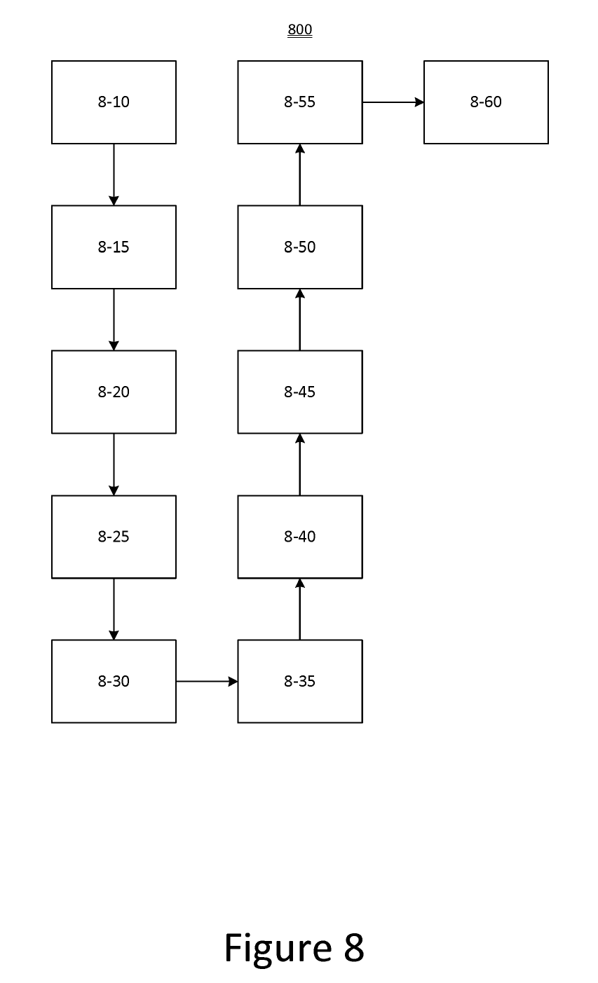

Referring to FIGS. 7 and 8, an operation 800 for conducting a remote transaction using the payment IC card 110 is described. A remote transaction, for the purposes of this description, is one where the payment IC card 110 is not physically presented to the vendor 155, such as when making an online purchase or a purchase over the telephone.

For convenience of description, it is assumed in the following description that the user 120 desires to effect payment by way of their MasterCard™ credit card which has been activated on key ‘4’ of their payment IC card 110. It is to be understood, however, that the invention is not so limited, and that the following operation 800 is applicable regardless of which payment scheme is used, and which key of the payment IC card 130 is activated.

The operation 800 commences at 8-10, where the user 120 is prompted by the vendor 155 to provide their payment details. The payment details are, for example, the credit card number or primary account number (PAN), cardholder's name, expiry date, CCV2 number, and the like.

At 8-15, the user 120 selects one of the selectable presets of the payment IC card 110, and hence the payment scheme account corresponding therewith, to effect payment. In this example, the user 120 presses key ‘4’ using the keypad 220.

At 8-20, upon pressing key ‘4’, the display 210 generates a screen 710 (FIG. 7) displaying “MASTRCARD1”, to confirm to the user 120 that key ‘4’ is activated for use with their MasterCard™ account.

At 8-25, the user 120 indicates to the payment IC card 110 the type of transaction that is about to be made. Accordingly, the user 120 in this example indicates to the card that a remote transaction is to be made. This indication can be made by way of a manipulation of the keypad 220 in a known sequence. In one form, the key ‘1’ is pressed to indicate a remote transaction, as exemplarily illustrated by screen 720 (FIG. 7).

At 8-30, the user is subsequently presented with a screen 730 (FIG. 7) prompting the user 120 to enter in a PIN.

At 8-35, the user 120 enters in a PIN. The PIN may be a PIN specific to the selected preset such that each preset requires a different PIN, or may be specific to the payment IC card 110 such that one PIN is valid for all presets. In one form, regardless of whether the entered PIN is valid or not, the user 120 is presented with a screen 740 (FIG. 7) displaying an identifying value 770. The identifying value 770 is generated from a number of inputs, including one or more of the PIN, the identifier paired in the payment IC card 110 to key ‘4’, the current time, and/or the key number pressed (in this case, key ‘4’). In another form, the identifier paired to key ‘4’ is itself the identifying value 770 presented on the screen 740 if the PIN is valid, and if an invalid PIN is entered no identifying value 770 is presented and/or an error message is presented.

At 8-40, the identifying value 770 is provided to the vendor 155/160, along with payment details (e.g. the aforementioned credit card number/PAN, cardholder's name, and expiry date) that are typical for a remote transaction. In one embodiment, the identifying value 770 is a card expiry date, and is accordingly provided to the vendor 155/160 naturally as part of the typical process for conducting a remote transaction.

At 8-45, the vendor 155/160 enters the received payment details and identifying value into their vendor payment system. The vendor payment system recognizes from the card number that the payment IC card 110 is, for example, a Visa™ card (or other card accepted by the vendor) issued by the wallet provider 135, and accordingly provides the aforementioned payment details, including the identifying value, amount to be debited, and other information as required, to the wallet server 130 for processing.

At 8-50, the wallet server 130 receives the payment details, including the identifying value, the amount to be debited, and other required information. From the identifying value, the wallet server 130 determines that key ‘4’ was pressed by the user 120. The wallet server 130 is able to determine that key ‘4’ was pressed because, as previously described, the wallet server 130 has pre-stored therein in association with key ‘4’ either a matching identifying value, or information from which a matching identifying value can be generated.

The wallet server 130 subsequently retrieves the account details for the user's MasterCard™ credit card that is linked with key ‘4’, including the actual MasterCard™ primary account number, actual MasterCard™ expiry date, actual MasterCard™ CCV2 number, and the like.

At 8-55, the wallet server 130 provides the user's actual MasterCard™ primary account, actual CCV2 number, actual expiry date, and other payment details to the MasterCard™ financial system 105B for processing.

At 8-60, the MasterCard™ financial system 105B receives the actual MasterCard™ primary account number, expiry date, CCV2 number, and other payment details, and verifies if the transaction should be approved. The transaction is approved or declined pursuant to the standard procedures of the financial system 105B. The approval or rejection of the transaction by the MasterCard™ financial system 105B is made known to the wallet server 130, who in turn informs the vendor/vendor's payment portal 155/160. Accordingly, the user's transaction with the vendor 155 is correspondingly approved or declined.

As the identifying value is locally unique (at least within a given duration of time), it will be understood that selecting a different preset will cause a different identifying value to be presented at step 8-35. Identifying values can be made locally unique either by pairing locally unique identifiers with each selectable preset, or, in the case where identifying values are generated each time at step 8-35, ensuring that the algorithm for generating the identifying values generates locally unique identifying values, at least for a given duration of time. For example, the algorithm for generating the identifying values can include as an input one or more of the identifier paired to the selected preset, the key number (e.g. key ‘4’) associated with the selectable preset, the PIN, the current time, and/or, if available, the aforementioned third identifier.

As mentioned above, in one form, entry of an invalid PIN at 8-35 will still generate an identifying value however this identifying value will have no matching counterpart in the wallet server 130. Generation of an identifying value with no matching counterpart in the wallet server 130, and subsequent receipt thereof, identifies to the wallet server 130 that an invalid PIN for that selected preset was entered into the payment IC card 110, and accordingly, the identity of the person operating the payment IC card 110 cannot be confirmed as an authorized user of the payment IC card 110. The transaction in this case is therefore terminated.

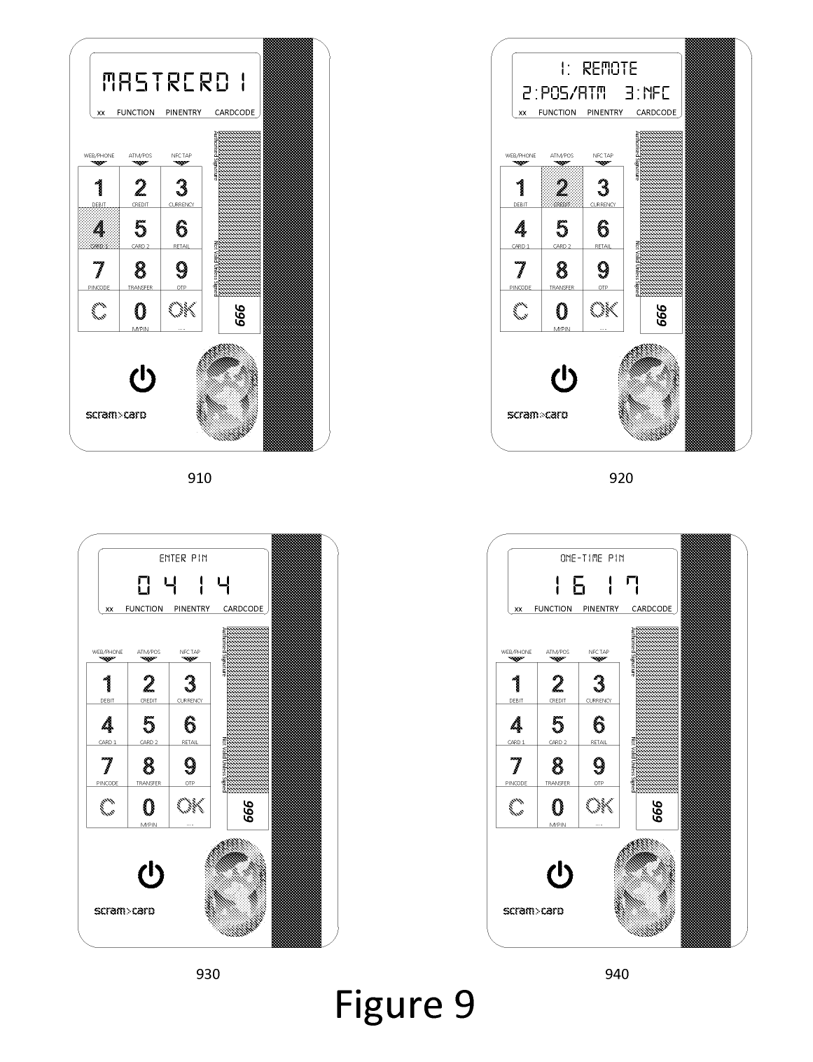

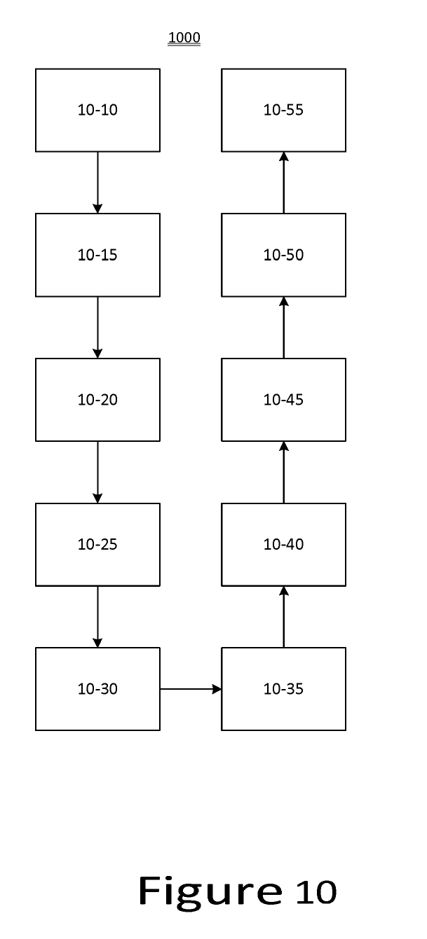

With reference to FIGS. 9 and 10, an operation 1000 for making a point-of-sale transaction using the payment IC card 110 is described. A point-of-sale transaction, for the purposes of this description, is one where the payment IC card 110 is physically presented to the vendor 155, such as when used with a vendor's POS device 150.

For convenience of description, it is assumed in the following description that the user 120 desires to effect payment by way of their MasterCard™ credit card which has been activated on key ‘4’ of their payment IC card 110. It is to be understood, however, that the invention is not so limited, and that the following operation 800 is applicable regardless of which payment scheme is used, and which key of the payment IC card 130 is activated.

The operation 1000 commences at 10-10, where the user 120 is prompted by the vendor to present their payment IC card 110 to effect payment.

At 10-15, the user 120 selects the selectable presets of the payment IC card 110 activated for their MasterCard™ account to effect payment. Accordingly, the user 120 presses key ‘4’ using the keypad 220.

At 10-20, upon pressing key ‘4’, the display 210 displays “MASTRCARD1”, as illustrated by screen 910 (FIG. 9), to confirm to the user 120 that key ‘4’ corresponds to their MasterCard™ account. The user 120 is then prompted to indicate to the payment IC card 110 what kind of transaction is to be conducted, as exemplarily illustrated by screen 920 (FIG. 9). Accordingly, the user 120 in this example indicates to the card that a point-of-sale transaction is to be made. This indication can be made by way of a manipulation of the keypad 220 in a known sequence. In a preferred form, the key ‘2’ is pressed to indicate a point-of-sale transaction.

At 10-25, the user 120 optionally validates their authority to use the payment IC card 110, to the payment IC card 110, by entering into the payment IC card 110 a PIN that is valid for the selected preset (as illustrated by screen 930 of FIG. 9). As mentioned previously, each preset can require a specific PIN, or a single PIN can be valid for all presets.

At 10-35, if a PIN is entered at 10-25, in one form a one-time PIN (OTP) is generated and displayed by the payment IC card 110 regardless of whether or not the entered PIN was valid for the selected preset. In another form, a OTP is generated and displayed only if the entered PIN was valid for the selected preset. Screen 940 of FIG. 9 illustrates the generation and display of the OTP.

At 10-40, the user 120 validates their authority to use the payment IC card 110 to the POS device 150. Validation of the user's authority is realized by, for example by way of the inserting, swiping, waving, or otherwise interacting the payment IC card 110 with the POS device 150, subsequently entering a valid PIN into the POS device 150, and the POS device 150 performing offline or online verification of the PIN. If steps 10-25 and 10-35 were performed, the valid PIN is the OTP generated in said steps.

Generation and use of a dynamic one-time PIN to validate the user's authority is described in further detail in the Applicant's PCT application no. PCT/AU2012/000110 (now published as WO/2012/106757), the contents of which are herein incorporated by reference.

At 10-45, upon successful validation of the user's authority, details of the payment IC card 110 (e.g. the PAN of the payment IC card 110) and other payment details are read or entered into the POS device 150 and sent to the wallet server 130. In particular, the identifier corresponding to key ‘4’ is itself used as an identifying value, or an identifying value is generated therefrom by the payment IC card 110, and made available to the POS device 150. The POS device 150 then sends the identifying value to the wallet server 130. In a preferred embodiment, the identifying value is a tag that is prescribed by the payment standard. In one form, the identifying value is a PAN Sequence Number prescribed by the EMV payment standard.

As the PAN Sequence Number is a piece of information that is already exchanged during POS/ATM transactions, no special modifications to the vendor payment system 150 is required to ensure that the identifying value is exchanged during the transaction. In one form, exchange of the identifying value in the form of a PAN Sequence Number (or other prescribed tag of the payment standard) takes place by way of the Application Protocol Data Unit (APDU) messaging protocol defined by ISO/IEC 7816-4, and used by the EMV payment standard.

At 10-50, the wallet server 130 receives the identifier and payment details, and derives from the identifier that the user 120 selected the preset mapped to key ‘4’. Accordingly, the wallet server 130 retrieves the user's MasterCard™ account details and provides the account details and payment details to the MasterCard™ financial system 105B for processing.

At 10-55, the MasterCard™ financial system 105B processes the transaction and either accepts or declines the transaction pursuant to their standard procedures. A notification of acceptance or rejection of the transaction is then provided back to the wallet server 130, who in turn notifies the vendor/POS device 150.

The system 10, payment IC card 110, and use thereof according to the present disclosure enables the user 120 to effect payment via multiple payment schemes 100A-D that the user 120 has accounts with, using a single card. The payment IC card 110 stores therein a plurality of locally unique identifiers which are used as identifying values (or to generate identifying values) during a transaction. Each identifying value corresponds with a matching identifying value stored in or capable of being generated by the wallet server 110. Accordingly, the wallet server 130 is able to identify from the identifying value which preset was selected by a user 120 of the payment IC card 110, and retrieve the actual account details for the payment scheme account corresponding to the selected preset. The actual account details can then be submitted to the appropriate financial system 105A-D for processing.

From the vendor's/POS device's point of view, the user 120 is effecting payment by the payment scheme represented by the primary account number of the payment IC card (e.g. Visa™), even if a different payment scheme is ultimately contacted by the wallet server 130 to make payment. Accordingly, the present invention further allows the user 120 to pay by a preferred, though less widely accepted, payment scheme such as American Express™, even when the vendor 155 does not accept payment by that payment scheme.

### ADVANTAGES

The advantages of the present invention include the ability for users to transact using any payment scheme with which they have an account, from a single card. Accordingly, there is no longer the need for users to carry with them multiple cards.

Moreover, the present invention allows users to essentially transact with a vendor using a payment scheme that the vendor does not accept. Accordingly, payment schemes such as Diners Club™ and American Express™ which tend to offer better incentives to users but which are not as widely accepted, my still be used by users at vendors which do not accept such payment schemes.

The present invention further obviates the need for collaboration or agreement between the various payment schemes. The technological solution presented by the present invention hence renders feasible what would otherwise be, from a business perspective, an unfeasible solution.

### VARIATIONS

It will of course be realised that while the foregoing has been given by way of illustrative example of this invention, all such and other modifications and variations thereto as would be apparent to persons skilled in the art are deemed to fall within the broad scope and ambit of this invention as is herein set forth.

Throughout the description and claims of this specification the word “comprise” and variations of that word such as “comprises” and “comprising”, are not intended to exclude other additives, components, integers or steps.

1. A system for effecting a financial transaction, the system comprising:
a payment IC card compatible with a payment card standard, the payment IC card having one or more selectable presets each identified by an identifier;
a wallet server storing, in association with respective identifying values, user payment scheme accounts of one or more payment schemes; and
a vendor payment system configured to facilitate transactions in accordance with the payment card standard and further operable to receive from the payment IC card an identifying value for subsequent transmission to the wallet server, wherein
the wallet server is configured to receive the identifying value from the vendor payment system and effect a financial transaction with a user payment scheme account stored in association with an identifying value matching the identifying value received from the vendor payment system, and
the identifying value is a tag prescribed by the payment standard, the tag selected from the group consisting of: a PAN Sequence Number and an expiry date value.

2. A system according to claim 1, wherein the vendor payment system includes a card reader, and the payment IC card is operable to interact with the card reader to transmit thereto the identifying value for subsequent transmission to the wallet server.

3. A system according to claim 1, wherein the payment IC card transmits the identifying value to the vendor payment system via an APDU message.

4. (canceled)

5. A system according to claim 1, wherein the identifying value is generated by the payment IC card from an identifier paired to a respective preset.

6. A system according to claim 1, wherein the payment standard is a payment standard selected from a group consisting of: the EMV payment standard and the PBOC payment standard.

7. (canceled)

8. A system according to claim 1, wherein:
the vendor payment system further comprises a payment portal configured to receive input from a user,
the payment IC card includes a display, and
the payment IC card is operable to display on the display the identifying value.

9. A system according to claim 8, wherein the payment portal includes a website, and the identifying value is communicated to the payment portal by input into the website.

10. A system according to claim 8, wherein the payment portal includes a at least partially automated call center, and the identifying value is communicated to the payment portal through telephony input.

11. A system according to claim 10, wherein the payment portal includes an at least partially automated call center, and the identifying value is communicated to the payment portal through telephony input, wherein the telephony input includes pulse dialing telephony signals generated by a telephony device.

12. A system according to claim 10, wherein the payment portal includes an at least partially automated call center, and the identifying value is communicated to the payment portal through telephony input, wherein the telephony input includes text messages generated by a telephony device.

13. A system according to claim 8, wherein the payment portal includes a manned call center, and the identifying value is communicated to the payment portal by voice input.

14. (canceled)

15. A system according to claim 1, wherein the wallet server is connected to financial systems of each payment scheme.

16. A system according to claim 15, wherein the wallet server is connected to financial systems of each payment scheme, wherein the wallet server is configured to provide the details of the payment scheme account stored in association with the received identifying value to a corresponding financial system to facilitate payment from a user to the vendor payment system.

17. A system according to claim 16, wherein the wallet server is operable to receive from the financial system an approval or rejection of the request for payment, and inform the vendor payment system of the same.

18. A system according to claim 1, wherein the payment IC card is operable by a user to select a selectable preset, and to transmit or display the identifier paired with the selected preset as the identifying value.

19. A system according to claim 1, wherein the payment IC card is operable by a user to select a selectable preset, generate an identifying value from the identifier paired with the selected preset, and transmit or display the identifying value.

20. A system according to claim 1, wherein the wallet server, upon receipt of the identifying value, is operable to identify and retrieve the details of the payment scheme account stored in association with a matching identifying value, and provide the details to the financial system of the corresponding payment scheme.

21. A payment integrated circuit (IC) card for effecting a financial transaction in accordance with a payment standard, the payment IC card comprising:
a human interface including a display and a keypad;
an integrated circuit (IC) chip compatible with the payment standard; and
a plurality of selectable presets each respectively associated with an identifier, each identifier is, or is used to generate, an identifying value associated with a payment scheme account, wherein
the selectable presets are operable by a user to configure the payment IC card for transaction via one of the plurality of payment scheme accounts, and
the identifying value is a tag prescribed by the payment standard, the tag selected from the group consisting of: a PAN Sequence Number and an expiry date value.

22. A payment IC card according to claim 21, wherein the payment IC card is configurable via the selectable presets to set one of the identifying values as an identifying value to be transmitted to a vendor payment system when requested thereby.

23. A payment IC card according to claim 22, wherein the payment IC card is configured to transmit the set identifying value to the vendor payment system in an APDU response to an APDU command from the vendor payment system.

24. (canceled)

25. (canceled)

26. A payment IC card according to claim 21, wherein the payment IC card is configurable via the selectable presets to set one of the identifying value as an identifying value to be displayed on the display of the human interface.

27. A payment IC card according to claim 26, wherein the set identifying value is displayed on the display of the human interface in a format facilitating human reading thereof.

28. A payment IC card according to claim 26, wherein the set identifying value is displayed on the display of the human interface in a format facilitating machine reading thereof.

29. (canceled)

30. A payment IC card according to claim 21, wherein the payment IC card is configured to operate in a first mode where an authentication code representing the identity of the user is inputted to the payment IC card, and the payment IC card is operable to generate a security PIN using one or more of the authentication code, a current time, the selected preset, and a pre-stored random seed, and wherein the security PIN is adapted for input to the vendor payment system to authorize the transaction.

31. A payment IC card according to claim 30, wherein the authentication code is a number.

32. A payment IC card according to claim 30, wherein the authentication code is a code generated from biometric information of the user.

33. A payment IC card according to claim 21, wherein the payment IC card is further configured to operate in a second mode in which an authentication code representing the identity of the user is inputted to the payment IC card, and upon successful validation of the authentication code, the payment IC card unlocks an NFC communication capability of the payment IC card allowing the set identifier to be transmitted via NFC communication to the vendor payment system.

34. A payment IC card according to claim 21, wherein the selectable presets are mapped to the keypad, whereby operation of the keypad operates the selectable presets.

35. A method for conducting an electronic payment transaction comprises:
selecting a preset on a payment IC card, the selected preset having an identifier associated therewith, the identifier being, or being used to generate, an identifying value;
providing the identifying value to a vendor payment system;
transmitting the identifying value from the vendor payment system to a server;
identifying at the server a payment scheme account corresponding to the transmitted identifying value; and
transmitting the details of the identified payment scheme account to a financial system of a payment scheme corresponding to the payment scheme account to effect a financial transaction using the payment scheme, wherein
the identifying value is a tag prescribed by the payment standard, the tag selected from the group consisting of: a PAN Sequence Number and an expiry date value.

36. A method according to claim 35, further comprising receiving an input indicative of whether the transaction to be conducted is a remote transaction or a point-of-sale transaction.

37. A method according to claim 36, wherein when applied to a remote transaction, the method further comprises the payment IC card receiving a PIN after the preset is selected, and displaying an identifying value associated with the selected preset if the PIN is valid, wherein the identifying value is displayed in a suitable form for input to the vendor payment system.

38. A method according to claim 36, wherein when applied to a remote transaction, the method further comprises the payment IC card receiving a PIN, the payment IC card generating the identifying value at least partially based on the PIN, and displaying the generated identifying value, wherein the identifying value is displayed in a suitable form for input to the vendor payment system.

39. A method according to claim 38, wherein the identifying value is generated further at least partially based on the identifier associated with the selected preset.

40. (canceled)

41. (canceled)

42. (canceled)

43. A method according to claim 36, wherein the method, when applied to a point-of-sale transaction, comprises the payment IC card receiving a PIN, the payment IC card generating an identifying value at least partially based on the received PIN, and making the generated identifying value available for provision to the vendor payment system.

44. A method according to claim 43, wherein the identifying value is generated further at least partially based on an identifier paired to the selected preset.

45. A method according to claim 43, further comprising generating a security number based at least in part on the received PIN, and displaying the security number, wherein the security number is a one-time passcode (OTP) for input into the vendor payment system to authenticate a user of the payment IC card.

46. A method according to claim 36, wherein the method, when applied to a point-of-sale transaction, further receives an input indicative of whether the transaction is an NFC transaction, and if the receive input indicates that the transaction is an NFC transaction, receiving an authorizing PIN, unlocking an NFC communication capability integrated in the payment IC card if the authorizing PIN is valid, and transmitting the identifying value associated with the selected preset via NFC to the vendor payment system.

47. (canceled)

48. A method according to claim 36, wherein the method, when applied to a point-of-sale transaction, comprises the payment IC card receiving a PIN, the payment IC card generating an identifying value at least partially based on the received PIN, and making the generated identifying value available for provision to the vendor payment system.

49. A method according to claim 48, further comprising generating a security number based at least in part on the received PIN, and displaying the security number, wherein the security number is a one-time passcode (OTP) for input into the vendor payment system to authenticate a user of the payment IC card.
